(19) United States
(12) Patent Application Publication
(10) Pub. No.: US 2024/0340739 A1
(43) Pub. Date: Oct. 10, 2024

(54) MANAGEMENT SYSTEM, MANAGEMENT APPARATUS, AND MANAGEMENT METHOD

(71) Applicant: NEC Corporation, Minato-ku, Tokyo (JP)

(72) Inventors: Kosei Kobayashi, Tokyo (JP); Yusuke Shinohara, Tokyo (JP); Takanori Iwai, Tokyo (JP); Hayato Itsumi, Tokyo (JP); Koichi Nihei, Tokyo (JP); Kazuki Ogata, Tokyo (JP); Kei Yanagisawa, Tokyo (JP)

(73) Assignee: NEC Corporation, Minato-ku, Tokyo (JP)

(21) Appl. No.: 18/692,469

(22) PCT Filed: Oct. 11, 2021
(86) PCT No.: PCT/JP2021/037539

§ 371 Date: Mar. 15, 2024

(51) Int. Cl. H04W 36/12; H04W 36/30

(52) U.S. Cl. CPC H04W 36/12; H04W 36/30

(57) ABSTRACT

A process of switching a provision source server of a service for a mobile object is performed at a timing suitable for a service being provided. A management system or a management apparatus evaluates a degree of influence of a server switching process of switching a provision source server of a service for a mobile object, which is exerted on the service. The management system or the management apparatus decides a timing to switch the provision source server on the basis of an evaluation result of the evaluating and gives an instruction to switch the provision source server at the timing decided by the decision.

### TECHNICAL FIELD

The present disclosure relates to a management system, a management apparatus, and a management method.

### BACKGROUND ART

As a related art, Patent Literature 1 discloses an edge host computer apparatus. The edge host computer apparatus predicts a response delay time of a specific service on the basis of a calculation delay time taken for information processing from reception of a request for the specific service to response and a communication delay time taken for communication between a terminal apparatus requesting the specific service and its own apparatus. The edge host computer apparatus decides an edge host computer apparatus that provides the specific service on the basis of the response delay time answered from another edge host computer apparatus and the response delay time of the prediction result. The edge host computer apparatus performs setting in such a way that the decided edge host computer apparatus provides the specific service.

As another related art, Patent Literature 2 discloses a mobile terminal which is capable of performing wireless communication with a plurality of base stations, and includes a service determination means and a terminal control means. The service determination means determines whether or not it is a communication status in which a voice service is being provided while it is located in a cell which is under control of a first base station. The terminal control means performs a process for performing handover to a second base station when the service determination means determines that it is the communication state.

### CITATION LIST

### Patent Literature

Patent Literature 1: Japanese Unexamined Patent Application Publication No. 2020-137067
Patent Literature 2: Japanese Unexamined Patent Application Publication No. 2013-236336

### SUMMARY OF INVENTION

### Technical Problem

As described above, in the technique disclosed in Patent Literature 1, the edge host computer apparatus to which the terminal apparatus is connected is decided on the basis of the service response delay time including the calculation delay time and the communication delay time. However, switching of connection may cause temporary interruption or disconnection of application communication.

The technique disclosed in Patent Literature 2 is a technique for controlling a timing of handover between base stations depending on whether or not the voice service is being provided such that deterioration in service quality due to communication interruption is prevented, and is not a technique related to switching of a server that provides a service. Therefore, in the technology disclosed in Patent Literature 2, switching at a desired timing is not necessarily possible depending on an application being activated in the mobile terminal. This is because the communication and the application have different layers, and for example, a timing may not be good for the application even though a timing is good for the communication. Therefore, in the technology disclosed in Patent Literature 2, even though the connection destination is switched at a timing for preventing communication disconnection, a serious defect may occur depending on an application.

The present disclosure was made in light of the forgoing circumstances, and it is an object of the present disclosure to provide a management system, a management apparatus, and a management method which are capable of performing a process of switching a provision source server of a service for a mobile object at a timing suitable for a service being provided.

### Solution to Problem

In order to achieve the above object, the present disclosure provides, as a first aspect, a management system. The management system includes an evaluation means for evaluating a degree of influence of a server switching process of switching a provision source server of a service for a mobile object, which is exerted on the service, and a decision means for deciding a timing for switching the provision source server on the basis of an evaluation result of the evaluation means. The management system includes an instruction means for giving an instruction to switch the provision source server at the timing decided by the decision means.

The present disclosure provides, as a second aspect, a management apparatus. The management apparatus includes an evaluation means for evaluating a degree of influence of a server switching process of switching a provision source server of a service for a mobile object, which is exerted on the service, and a decision means for deciding a timing for switching the provision source server on the basis of an evaluation result of the evaluation means. The management apparatus includes an instruction means for giving an instruction to switch the provision source server at the timing decided by the decision means.

The present disclosure provides, as a third aspect, a management method. The management method includes performing an evaluation process of evaluating a degree of influence of a server switching process of switching a provision source server of a service for a mobile object, which is exerted on the service, and performing a decision process of deciding a timing for switching the provision source server on the basis of an evaluation result of the evaluation process. The management method includes giving an instruction to switch the provision source server at the timing decided by the decision process.

### Advantageous Effects of Invention

According to the present disclosure, it is possible to provide a management system, a management apparatus, and a management method which are capable of performing a process of switching a provision source server of a service for a mobile object at a timing suitable for a service being provided.

### BRIEF DESCRIPTION OF DRAWINGS

FIG. 1 is a block diagram illustrating a configuration example of a management system according to a first example embodiment of the present disclosure.

FIG. 2 is a block diagram illustrating a management apparatus which is a configuration example of the management system of FIG. 1.

FIG. 3 is a flowchart for explaining an example of a management method in the management system of FIG. 1 or the management apparatus of FIG. 2.

FIG. 4 is a block diagram illustrating another configuration example of the management system of FIG. 1.

FIG. 5 is a block diagram illustrating a configuration example of a mobile object in the configuration example of FIG. 4.

FIG. 6 is a schematic diagram for explaining a process example in the management system of FIG. 4.

FIG. 7 is a schematic diagram for explaining still another configuration example of the management system of FIG. 1 and a process example thereof.

FIG. 8 is a flowchart for explaining an example of a management method in a management system according to a second example embodiment of the present disclosure.

FIG. 9 is a schematic diagram for explaining a management system according to a third example embodiment of the present disclosure and a process example thereof.

FIG. 10 is a flowchart for explaining an example of a management method in the management system of FIG. 9.

FIG. 11 is a block diagram illustrating a configuration example of a computer apparatus.

### EXAMPLE EMBODIMENT

Hereinafter, example embodiments according to the present disclosure will be described in detail with reference to the drawings. Note that omission and simplification are made as appropriate in the description and drawings described below for clarity of description. In addition, in each of the drawings described below, the same elements and similar elements are denoted by the same reference signs, and a duplicate description is omitted as necessary.

### First Example Embodiment

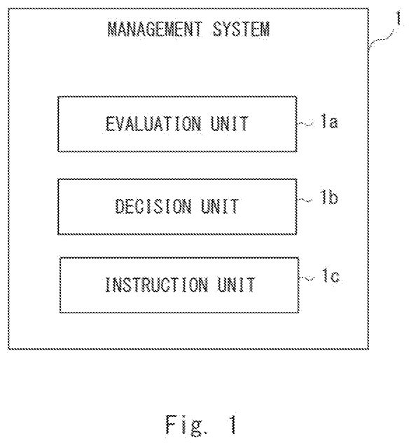

FIG. 1 is a block diagram illustrating a configuration example of a management system according to a first example embodiment of the present disclosure. A management system 1 can include an evaluation unit (evaluation means) 1a, a decision unit (decision means) 1b, and an instruction unit (instruction means) 1c.

The management system 1 can include a system that performs a server switching process of switching a server (provision source server) of a service provision source to a mobile object, and performs control of the switching, that is, management of the server switching process. The server switching process accompanies a period of time during which communication is interrupted or a period of time during which a service is temporarily interrupted, but as can be seen from the following description, the management system 1 appropriately decides a switching timing of the server switching process. Hereinafter, the description will proceed under the assumption that the management system 1 has a function of performing the server switching process, but this function is not essential in the management system 1 (or the management apparatus 2 to be described later), and other systems connected to the management system 1 can be provided with this function.

Further, the mobile object may be, for example, a pedestrian, a bicycle, an automobile (a taxi, a bus, a truck, or the like, and the purpose thereof does not matter), a work vehicle other than an automobile, or a ground vehicle such as a train. Further, the mobile object may be an object that moves under water or over water such as a ship or an underwater drone or an object (flying object) that moves in the air such as an aircraft or a flying drone. Furthermore, the mobile object may be a mobile robot such as an automated guided vehicle (AGV).

Further, it does not matter whether the mobile object has a function of moving according to autonomous control, a function of moving according to operation by an operator, or both functions. In a case in which the mobile object has a function of moving according to autonomous control, the mobile object performs automatic driving (autonomous driving) on the basis of information of a sensor mounted on the mobile object. Further, the mobile object may be configured to be able to switch between, for example, automatic driving and manual driving by an occupant (for example, a driver in a vehicle in the case of an automatic driving vehicle). In this case, the mobile object may switch from the manual driving to the automatic driving or from the automatic driving to the manual driving in response to an instruction transmitted from a provision source server, for example, as a driving-switching service provided from the provision source server.

Examples of the service include various types of services such as an emergency alert service such as collision, a traffic jam information distribution service, an approach notification service of an emergency vehicle, a dynamic map distribution service, the driving switching service, a music distribution service, and a video distribution service. The service may be mainly provided by, but is not limited to, an application program (hereinafter, “application”). Further, an information transmission direction may be from the server to the mobile object or from the mobile object to the server. That is, even in a case in which the server is a service provision source, an information transmission source is not necessarily the server, and the information transmission source may be the mobile object. For example, in order to provide a video or an analysis result thereof to a third party by using a relay service provided by the server, the video may be distributed from the mobile object to the server.

The server switching process is a process of switching the provision source server from a server (also referred to as a switching source server) that currently provides the service to a server (also referred to as a switching destination server) that is a switching destination. The provision source server may be, but is not limited to, an edge server such as a multi-access edge computing (MEC) server installed at a position close to the mobile object in order to improve a processing speed including a communication delay. Further, in a case in which the server switching process is executed, the server serving as the switching destination is decided, but in the present disclosure, basically, decision by selection of the switching destination server or the like is not particularly limited. Preferably, the switching destination server is decided on the basis of predetermined criteria, and for example, a server geographically closest to the mobile object may be decided as the switching destination server, or a server instructed to any server included in the management system 1 or other systems may be decided as the switching destination server. Further, a server on a cloud system may be decided as the switching destination server.

In the management system 1, the evaluation unit 1a, the decision unit 1b, and the instruction unit 1c may be distributed and mounted on a plurality of apparatuses, and a distribution method thereof is not limited. For example, the management system 1 may be configured with an apparatus including the evaluation unit 1a, an apparatus including the decision unit 1b, and an apparatus including the instruction unit 1c. Each apparatus may be configured as a computer apparatus including hardware including, for example, one or more processors and one or more memories. Then, at least some of functions of the units mounted in each apparatus may be implemented in such a way that one or more processors operate in accordance with a program read from one or more memories.

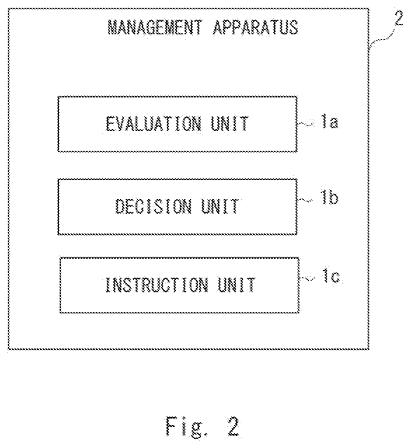

Further, as illustrated in FIG. 2, the management system 1 may be constructed as a single management apparatus 2 including the evaluation unit 1a, the decision unit 1b, and the instruction unit 1c. FIG. 2 is a block diagram illustrating the management apparatus 2 which is a configuration example of the management system 1 of FIG. 1. The management apparatus 2 may be configured as a computer apparatus including hardware including, for example, one or more processors and one or more memories. At least some of functions of the respective units in the management apparatus 2 may be implemented in such a way that one or more processors operate in accordance with a program read from one or more memories. Further, the management apparatus 2 may be implemented in such a way that the functions of the respective units are distributed to separate apparatuses, and a distribution method thereof is not limited. For example, the management apparatus 2 may be configured with an apparatus including the evaluation unit Ta, an apparatus including the decision unit 1b, and an apparatus including the instruction unit 1c.

Next, the respective units Ta to Tc will be described.

The evaluation unit 1a evaluates the degree of influence of the server switching process of switching the provision source server of the service for the mobile object, which is exerted on the service. As can be seen from the statement that the method of deciding the switching destination server in the server switching process is not limited in the present disclosure, an evaluation target of the evaluation unit 1a is the degree of influence indicating how much the service is influenced if the server switching process is assumed to be executed. Therefore, the evaluation target of the evaluation unit 1a basically does not indicate the degree of influence of a delay or the like occurring after connection to the switching destination server.

An evaluation result of the evaluation unit 1a may be information indicating the presence or absence of influence but may be information indicating a corresponding influence level among a plurality of influence levels. Examples of information serving as the basis of evaluation, an evaluation method, and the like will be described later, but it is desirable that the evaluation unit 1a can evaluate the degree of influence.

The decision unit 1b decides a timing to switch the provision source server on the basis of the evaluation result of the evaluation unit 1a. The timing decided by the decision unit 1b may be basically a timing with a low degree of influence or may be, for example, a timing with a degree of influence lower than a predetermined degree of influence. Of course, the timing to be decided is not limited thereto, but it is desirable to avoid a timing with a high degree of influence. Further, the decision unit 1b may decide the timing by taking into account information as well as the evaluation result of the evaluation unit 1a.

The instruction unit 1c gives an instruction to switch the provision source server at the timing decided by the decision unit 1b. This instruction may be an instruction to provide the service, which is being provided from the switching source server to the mobile object, from the switching destination server or an instruction to provide the service related to the service, which is being provided from the switching source server to the mobile object, from the switching destination server. As can be understood from the example of the emergency alert service, the instruction given by the instruction unit 1c is executed for the purpose of continuing the service, but the service may be changed before and after the server switching process as in the latter example.

Further, as an example of giving the latter instruction, for example, there is a case in which services which are similar but distinct (for example, services whose provision sources are different such as local public organizations) are provided depending on an area. In this example, as a mobile object 50 moves across areas, a service provided by an original area may be switched to a service provided by another equivalent area. However, completely different types of services may be provided before and after the server switching process.

Further, an instruction destination of the instruction unit 1c varies depending on a system configuration in which the service is being provided to the mobile object, a relationship on a system between the switching source server and the switching destination server, or the like. For example, a core network system of a communication network, a switching source server, a management node such as a management server that manages a switching source server, a switching destination server, a management node such as a management server that manages a switching destination server, or the like can be the instruction destination. Further, the number of layers or a layer structure of a server for managing a plurality of servers that can be a service provision destination are not limited. Instruction content of the instruction unit 1c may be an instruction to change routing in a network (communication route change) or an instruction to change a communication address in order to change the service provision source server from the switching source server to the switching destination server.

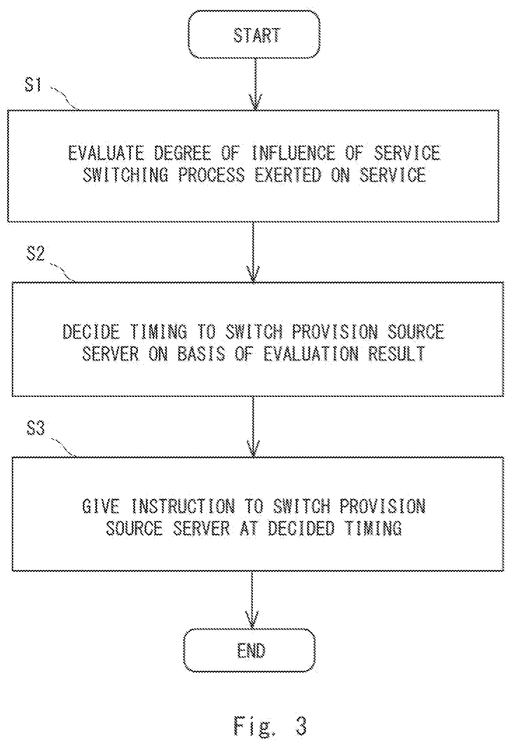

Next, a management method in the management system 1 or the management apparatus 2 having the above-described configuration will be described with reference to FIG. 3. FIG. 3 is a flowchart for describing an example of the management method.

In this management method, first, the evaluation unit 1a executes the evaluation process of evaluating the degree of influence of the server switching process exerted on the service (step S1). Next, the decision unit 1b executes the decision process of deciding the timing to switch the provision source server on the basis of the evaluation result in the evaluation process (step S2). Then, the instruction unit 1c gives an instruction to switch the provision source server at the timing decided in the decision process (step S3). The server switching process is executed on the basis of the instruction of step S3. The process of steps S1 to S3 can be executed at predetermined intervals, but is not limited thereto, and for example, the process of steps S1 to S3 may be executed on the basis of a predetermined standard in such a way that the process is not performed for a certain period immediately after the server switching processing is executed. The process of step S1 may be performed every certain period or when a predetermined condition is satisfied. For example, it may be determined whether or not the mobile object enters a predetermined area, and the process of step S1 may be performed when the mobile object enters the predetermined area.

As described above, in the present example embodiment, at the time of switching the service provision source server for the mobile object (the vehicle or the like), the degree of influence of the server switching process exerted on the service is evaluated, the timing of switching the server is decided on the basis of the evaluation result, and the switching instruction is given. Therefore, according to the present example embodiment, it is possible to perform the process of switching the provision source server of the service to the mobile object at timing suitable for the service being provided.

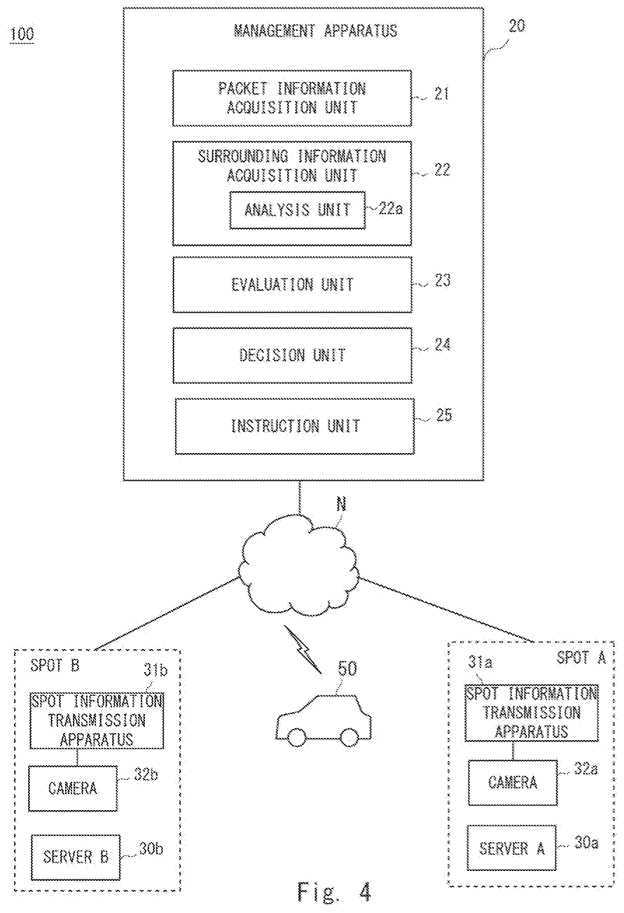

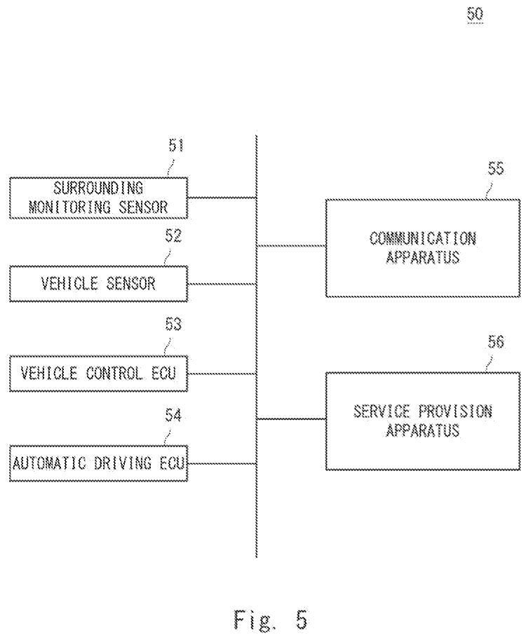

Next, a more specific evaluation method example and operation example will be described with another configuration example of the management system 1 of FIG. 1 with reference to FIGS. 4 to 6 while describing. First, an overview of this configuration example will be described with reference to FIGS. 4 and 5. FIG. 4 is a block diagram illustrating another configuration example of the management system 1 of FIG. 1. FIG. 5 is a block diagram illustrating a configuration example of a mobile object in the configuration example of FIG. 4, and is a diagram mainly illustrating an information processing apparatus mounted on the mobile object.

A management system 100 illustrated in FIG. 4 includes a management apparatus 20 which is an example of the management apparatus 1, and servers, which are arranged at spots A and B and can provide a service to the mobile object 50, is able to establish connection with the management apparatus 20 via a network N. Of course, the management apparatus 20 may be connected to servers arranged at three or more spots.

The network N may include, for example, a fifth generation mobile communication system or a core network system of a wireless communication network using a communication line standard such as long term evolution (LTE) local 5G, 4G, or 3G. Further, the network N may include other network systems, for example, a network system of a WiFi (registered trademark) standard. Of course, the network N may be a combination of a plurality of types of network systems.

In FIG. 4 and subsequent drawings, an example in which the mobile object 50 serving as a service provision target is the vehicle is illustrated, the description thereof will proceed under the assumption that the mobile object 50 is the vehicle, but the present disclosure is not limited thereto, and the service provision target may be other types of mobile objects. For example, a mobile communication terminal apparatus such as a smartphone carried by a passenger in the mobile object 50 may be set as a mobile object serving as a service provision target. In this case, the mobile communication terminal apparatus may be connected to the mobile object 50 in a wired or wireless manner and acquire vehicle information such as a vehicle speed in the mobile object 50, information indicating a surrounding situation, or the like. Further, the management system 100 may be referred to as a service provision system because it is intended to provide a service to the mobile object 50.

In the management system 100, a spot information transmission apparatus 31a and a camera 32a are arranged at the spot A together with a server A 30a that can be a service provision source, and a spot information transmission apparatus 31b and a camera 32b are arranged at the spot B together with a server B 30b that can be a service provision source. Servers such as the server A 30a and the server B 30b serving as the service provision sources or base stations connected to the servers may be interspersed in units of intersections.

In order to simplify the description, the following description will proceed with an example in which the server A 30a is decided as the provision source server and the server B 30b is decided as the switching destination server will be described. Further, in order to simplify the description, the following description will proceed with an example in which the server A 30a, the spot information transmission apparatus 31a, and the camera 32a are arranged at the same spot (certain intersection) A, and the server B 30b, the spot information transmission apparatus 31b, and the camera 32b are arranged at the same point (certain intersection) B.

However, the server or the base station connected to the server, the spot information transmission apparatus, and the camera need not to be arranged at the same spot, and a geographical interval at which the server or the base station connected to the server is installed may be different from a geographical interval at which the camera or the like is installed. Further, it is assumed that the server, the spot information transmission apparatus, and the camera are connected to the management apparatus 20 via the same network N, but the present disclosure is not limited thereto, and the server, the spot information transmission apparatus, and the camera may be connected to the management apparatus 20 via different networks.

Further, the server A 30a is incorporated into the management system 100 in a state in which the service can be provided to the mobile object 50 via the network N. Specifically, in order to provide the service to the mobile object 50 via the wireless communication, a wireless base station or a wireless relay station capable of performing wireless communication with the mobile object 50 may be connected to the server A 30a. Furthermore, a plurality of mobile objects 50 that can provide the services may be provided, and in this case, the management apparatus 20 can manage the service switching process for each of the mobile objects 50. Further, although the server A 30a has been described, similar description applies to the server B 30b. Basically, the server A 30a and the server B 30b are different in that the server A 30a is a server that is currently providing the service to the mobile object 50, whereas the server B 30b is a server that is going to provide the service after switching as the switching destination.

Prior to the description of the management apparatus 20, a configuration example of the information processing apparatus mounted on the mobile object 50 in an example in which the mobile object 50 is the service provision target will be described with reference to FIG. 5.

As illustrated in FIG. 5, the mobile object 50 may include a surrounding monitoring sensor 51, a vehicle sensor 52, a vehicle control electric control unit (ECU) 53, an automatic driving ECU 54, a communication apparatus 55, and a service provision apparatus 56. In the mobile object 50, these components are configured so as to be able to communicate with one another via a network such as a local area network (LAN) or a controller area network (CAN).

The surrounding monitoring sensor 51 is a sensor that monitors a situation surrounding the mobile object 50. In the following description, the surrounding monitoring sensor 51 will be described using a camera as an example, but the present invention is not limited thereto. Examples of the surrounding monitoring sensor 51 include a camera, a depth sensor, a radar, and light detection and ranging (LiDAR). The surrounding monitoring sensor 51 may, for example, include a plurality of cameras that capture images of the front, rear, right, and left sides of the vehicle. The surrounding monitoring sensor 51 may include a camera that captures an image of the inside of the mobile object 50 or may include a temperature sensor that measures an ambient temperature.

The vehicle sensor 52 is a sensor that detects various states of the mobile object 50, that is, vehicle information of the mobile object 50. The vehicle sensor 52 includes, for example, sensors such as a vehicle speed sensor that detects vehicle speed, a steering sensor that detects a steering angle, an accelerator position sensor that detects an opening degree of an accelerator pedal, and a brake effort sensor that detects a depression amount of a brake pedal, and the like. The vehicle sensor 52 or the surrounding monitoring sensor 51 may include a position information sensor that acquires position information of the mobile object 50, which can be exemplified by a satellite positioning sensor such as a global positioning system (GPS).

The vehicle control ECU 53 is an electronic control apparatus that controls driving and others of the mobile object 50. In general, the electronic control apparatus is provided with a processor, a memory, an input/output (I/O), and a bus that connects them. On the basis of sensor information output from the vehicle sensor 52, the vehicle control ECU 53 executes various controls, such as control of a fuel injection amount, control of an engine ignition timing, and control of a power steering assist amount.

The automatic driving ECU 54 is an electronic control apparatus that controls automatic driving of the mobile object 50. The automatic driving ECU 54 obtains sensor information from the surrounding monitoring sensor 51 and the vehicle sensor 52, and controls automatic driving of the mobile object 50 on the basis of the obtained sensor information.

The communication apparatus 55 is configured as an apparatus that provides wireless communication between the mobile object 50 and the network N (see FIG. 4). The communication apparatus 55 includes a wireless communication antenna, a transmitter, and a receiver as a hardware configuration. Further, the communication apparatus 55 includes a processor, a memory, an I/O, and a bus that connects these. The function of each unit in the communication apparatus 55 is implemented, for example, in such a way that a control program stored in the memory is executed by the processor.

The service provision apparatus 56 is an apparatus that receives the service from the server A 30a and provides the service to the inside of the mobile object 50 or an operator of the mobile object 50, and can be configured with an ECU, a CPU, or the like. A process of providing the service may be implemented by incorporating a service provision program into a general-purpose information processing apparatus in an executable manner. Further, the service provision apparatus 56 may be incorporated, as, for example, a service provision program or the like, into other apparatuses such as a navigation system mounted on the mobile object 50.

The service provision apparatus 56 may give, to the vehicle control ECU 53 or the automatic driving ECU 54, a notification to activate an alert in a system in the vehicle depending on a type of service, or may provide the service from a display unit, a voice output unit, or the like provided in a separately mounted navigation system or the like.

The description returns to FIG. 4. The management apparatus 20 may include an evaluation unit 23, a decision unit 24, and an instruction unit 25, which correspond to the evaluation unit 1a, the decision unit 1b, and the instruction unit 1c, respectively, and include a packet information acquisition unit 21 and a surrounding information acquisition unit 22. Further, the management apparatus 20 may be implemented in such a way that the functions of the respective units are distributed to separate apparatuses, and a distribution method thereof is not limited. For example, the management apparatus 20 may be configured with an apparatus including the packet information acquisition unit 21, an apparatus including the surrounding information acquisition unit 22, an apparatus including the evaluation unit 23, an apparatus including the decision unit 24, and an apparatus including the instruction unit 25.

The evaluation unit 23 may evaluate the degree of influence of the server switching process of switching the provision source server of the service for the mobile object, which is exerted on the service, on the basis of communication packet information for communication between the provision source server (the server A 30a in this example) serving as the switching source and the mobile object 50. For example, various types of information described in a header of a communication packet, such as an Internet protocol (IP) address of a transmission source, an IP address of a destination, a port number, and a flag indicating contents of data, can be used as the communication packet information. Alternatively, the evaluation unit 23 may evaluate the degree of influence of the server switching process of switching the provision source server of the service for the mobile object, which is exerted on the service, on the basis of surrounding information indicating the surrounding environment of the mobile object 50. The surrounding information may be information indicating an object, an environment, or the like physically present around the mobile object 50, and may be referred to as real world information. Further, the evaluation unit 23 may evaluate the degree of influence on the basis of both the communication packet information and the surrounding information. Hereinafter, the information used for evaluation by the evaluation unit 23 is also referred to as evaluation target information.

The evaluation target information may be current information at a time point of execution of evaluation by the evaluation unit 23, prediction information obtained by predicting information in the future from at the time point of execution of evaluation by the evaluation unit 23, or both pieces of information. That is, both the communication packet information and the surrounding information may be current information, prediction information, or both of them. The current information is information obtained as information actually measured at the time point of execution of evaluation, and the prediction information is current information actually measured at the time point of execution of evaluation or information obtained by predicting the future on the basis of the current information and past information.

For acquisition of the evaluation target information, the communication packet information may be executed by the packet information acquisition unit 21, and the surrounding information may be executed by the surrounding information acquisition unit 22.

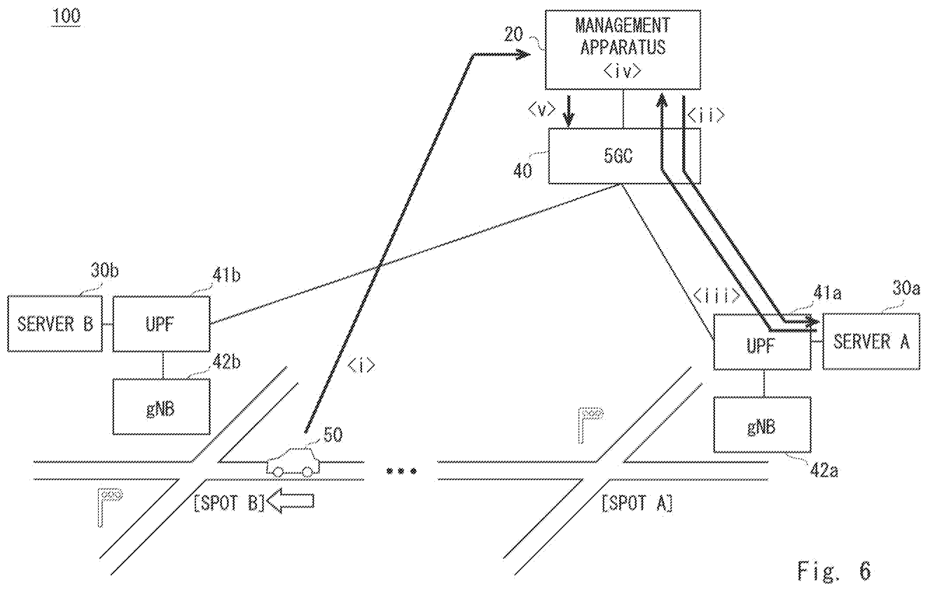

The packet information acquisition unit 21 may acquire the communication packet information for communication between the server A 30a and the mobile object 50 via the network N from the server A 30a or the mobile object 50 via the network N. Alternatively, the packet information acquisition unit 21 may acquire the communication packet information for communication between the server A 30a and the mobile object 50 from a wireless base station of a wireless communication network, a core network system, or the like, which is used between the server A 30a and the mobile object 50. An acquisition path and an acquisition method of the communication packet information and other traffic information (which will be described later) are not limited. Further, an example of the core network system will be described later with reference to FIG. 6.

The actually measured communication packet information can be regarded as information indicating a communication traffic at the time of actual measurement. Further, when a highly accurate prediction method is employed, the predicted communication packet information can be regarded as information indicating a communication traffic to be generated in the future. The predicted communication packet information may be, for example, a prediction result of a communication end timing in a case in which communication is currently occurring or a prediction result of a timing at which communication will occur next in a case in which communication is not currently occurring.

The predicted communication packet information can be acquired as an output of a prediction unit in which a prediction unit that is disposed inside the management apparatus 20 such as inside the packet information acquisition unit 21, and executes prediction from current information or current information and past information. Alternatively, the prediction unit may be disposed in an apparatus in the management system 100 other than the management apparatus 20 or an apparatus connected to the management system 100, and the packet information acquisition unit 21 may receive the predicted communication packet information from the apparatus. The prediction in the prediction unit may be executed by, for example, various time-series prediction algorithms or machine learning algorithms, but the present disclosure is not limited thereto. Further, the management apparatus 20 may acquire traffic information indicating a communication traffic by using information other than the communication packet information, and include the traffic information in the evaluation target information. The traffic information is, for example, a communication amount, a delay amount, a transmission error rate, and a retransmission rate of data exchanged between the server A 30a and the mobile object 50. Further, as the prediction information for the communication packet information, information, which is predicted on the basis of destination information of the mobile object 50 acquired as part of the vehicle information by the surrounding information acquisition unit 22, may be employed.

In a case in which the communication packet information is used as the evaluation target information, the evaluation unit 23 evaluates the degree of influence on the basis of the communication packet information. As a simple example, the evaluation unit 23 may determine whether communication is occurring or not on the basis of the communication packet information, and evaluate the former as having a high degree of influence and the latter as having a low degree of influence. For example, in a case in which a new communication packet has not been generated for a predetermined period of time or more since the last communication packet has been generated, it can be determined that communication is not occurring. Alternatively, it may be determined that communication is not occurring in a case in which the amount of communication packets within a predetermined period of time is equal to or less than a predetermined amount. Alternatively, the degree of influence may be evaluated in accordance with the amount of communication packets within a predetermined period of time in such a way that the degree of influence increases as the amount of communication packets increases.

Further, as another example, the evaluation unit 23 may classify the communication packet for each application on the basis of the IP address, the port number, or the like described in the header of the communication packet, and determine whether communication is occurring or not for each application by using a method similar to that described above. The application herein may be referred to as a service. The evaluation unit 23 may evaluate the degree of influence as “high” in a case in which communication of an application with a high degree of importance is occurring, and evaluate the degree of influence as “medium” in a case in which communication of an application with a medium degree of importance is occurring. Further, the evaluation unit 23 may evaluate the degree of influence as “low” in a case in which communication of an application with a low degree of importance is occurring, and evaluate the degree of influence as “none” in a case in which no communication is occurring. The packet of the application with the high degree of importance may be determined on the basis of whether or not a packet is a packet having information specified in advance. The result of the determination as to whether the packet has the information specified in advance may be included in the communication packet information acquired by the packet information acquisition unit 21, or may be determined by the packet information acquisition unit 21 or the evaluation unit 23 without being included in the communication packet information.

Further, as another example, the evaluation unit 23 may determine the degree of importance of the packet on the basis of the communication packet information, evaluate that the degree of influence is high in a case in which the degree of importance of the packet is high, and evaluate that the degree of influence is low in a case in which the degree of importance of the packet is low. The degree of importance of the packet may be determined on the basis of whether or not the packet is a packet having information specified in advance. The result of the determination as to whether the packet has the information specified in advance may be included in the communication packet information acquired by the packet information acquisition unit 21, or may be determined by the packet information acquisition unit 21 or the evaluation unit 23 without being included in the communication packet information.

As a specific example, in the case of video data with the H.264 format, the video data includes a frame which is called an I frame holding all pieces of information related to the frame and a frame which is called a P frame or a B frame holding only difference information from other frames. Here, the I frame is a frame serving as a reference of the P frame or the B frame, and can be regarded as a frame having the higher degree of importance than the P frame or the B frame. Therefore, the evaluation unit 23 may evaluate the degree of importance of the communication packet of the I frame higher than the degree of importance of the communication packet of the P frame or the B frame.

For example, it can be said that it is useful to perform the determination on the packet with the high degree of importance because the degree of importance of information may be different eve in the packets for the same application. Further, the determination on the packet with the high degree of importance and the determination on the application with the high degree of importance can be used together.

The surrounding information acquisition unit 22 acquires the surrounding information indicating the surrounding environment of the mobile object 50. As described above, the surrounding information may be information indicating an object, an environment, or the like which is physically present around the mobile object 50. Since movement of the mobile object 50 is accompanied by a relative change in the surrounding environment, the surrounding environment may include information related to movement of the mobile object 50 itself. The surrounding information acquisition unit 22 may be configured to acquire surrounding information to be used as evaluation target information. Alternatively, the surrounding information acquisition unit 22 may be configured to acquire analysis target information, analyze the acquired analysis target information, and obtain surrounding information as a result of analysis. The analysis target information is information in which information indicating the surrounding environment of the mobile object 50 is directly or figuratively included, and is information serving as a source for obtaining the surrounding information used as the evaluation target information by analysis. In this case, the surrounding information acquisition unit 22 may include an analysis unit 22a that analyzes the acquired analysis target information and uses the analysis target information as surrounding information that can be used as the evaluation target information.

A method of performing the analysis by the analysis unit 22a is not limited as long as the surrounding information to be used as the evaluation target information can be obtained. For example, the analysis unit 22a may perform image analysis on a camera video serving as the analysis target information and obtain information indicating the weather as the surrounding information, or may average temperature values for the past several minutes as the analysis target information and obtain an average temperature values as the surrounding information. As in these examples, the analysis unit 22a may obtain the surrounding information by performing the analysis process such as the image analysis or the statistical process on the analysis target information.

The surrounding information or the analysis target information may be acquired from the mobile object 50 or may be acquired from other mobile objects located around the mobile object 50 via the network N. In any case, information obtained by a camera, a position information sensor, a temperature sensor, other sensors, or the like mounted on the mobile object may be acquired as the surrounding information or the analysis target information.

The surrounding information or the analysis target information acquired from the mobile object 50 may be a camera video (video data) which is acquired by the surrounding monitoring sensor 51 and transmitted by the communication apparatus 55, or the vehicle information. The vehicle information may include sensor information such as vehicle speed information or position information which is acquired by the vehicle sensor 52 and transmitted by the communication apparatus 55, information of a destination or a current location indicated by the navigation system, or the like. Further, the surrounding information or the analysis target information acquired from the mobile object 50 may include driving control parameters used in at least one of the vehicle control ECU 53 and the automatic driving ECU 54. The driving control parameters may include, for example, stop control information, acceleration information (for example, an accelerator opening degree or a depression amount of a brake pedal), and information indicating an operation amount of a steering wheel. Further, the surrounding information or the analysis target information acquired from the mobile object 50 may include traffic control parameters. The traffic control parameter may include traffic light information (indicated state or cycle information) acquired by the mobile object 50 via the communication apparatus 55. Instead of acquiring the traffic light information via the communication apparatus 55, the traffic light information may be acquired by recognizing a traffic light state by using the surrounding monitoring sensor 51.

As another example, the surrounding information or the analysis target information may be acquired from an information acquisition device installed on a path along which the mobile object 50 moves, or may be acquired from an information provision server. The information acquisition device may be, for example, a camera, a temperature sensor, other sensors, or the like. The information acquisition device may be a device installed as a part of the traffic infrastructure as illustrated by the camera (roadside camera) 32a, the spot information transmission apparatus 31a connected thereto, or the like in FIG. 4. A server (not illustrated) that provides weather information or the like may be used as the information provision server.

An acquisition path of the surrounding information or the analysis target information is not limited thereto. For example, information exchanged by vehicle-to-vehicle communication such as (cellular vehicle to everything) C-V2X communication may be acquired by a road side unit (RSU). The management apparatus 20 may acquire the surrounding information or the analysis target information by receiving information from the RSU.

Of course, the surrounding information or the analysis target information may be information acquired from one or more types of acquisition sources. Further, the surrounding information or the analysis target information may be information acquired from a plurality of devices for one type of acquisition source. For example, the surrounding information or the analysis target information may be acquired from a plurality of information acquisition devices installed at different installation locations, or may be acquired from a plurality of information provision servers that provide different pieces of information.

In a case in which the surrounding information is used as the evaluation target information, the evaluation unit 23 evaluates the degree of influence on the basis of the surrounding information. As a simple example, the evaluation unit 23 may determine whether the area around the mobile object 50 is in a safe situation or a dangerous situation on the basis of the surrounding information, and evaluate the former as having a low degree of influence and the latter as having a high degree of influence. Further, regardless of the method of this determination process, for example, a threshold process as to whether or not the surrounding information satisfies a predetermined condition related to safety can be used. The relationship between safety and the degree of influence described here is based on an approach described below. That is, this approach is one in which, in a case in which the mobile object is receiving the emergency alert service from the server, even though temporary service interruption occurs due to the server switching process, when the surrounding area is safe, the degree of influence of the service interruption can be considered as being lower than that in a situation in which the surrounding area is dangerous.

This determination may be executed, for example, depending on whether or not the situation around the mobile object 50 indicates that the mobile object 50 itself is temporarily parked, whether or not it indicates that other vehicles or a person exists around the mobile object 50, or the like. In the case of this example, it may be determined that it is safe (the degree of influence is low) when the vehicle is temporarily parked, and it may be determined that it is safe (the degree of influence is low) when there is no other vehicles or person around. Further, the degree of influence may be determined as being higher as the driving speed is higher depending on the driving speed of the mobile object 50. Alternatively, it may be determined that the higher the speed limit or the legal speed is, the higher the degree of influence is, depending on the speed limit or the legal speed of the driving road of the mobile object 50.

Further, whether or not the area around the mobile object 50 is safe may be determined by including information such as weather or a time zone (nighttime/daytime), that is, information indicating good or poor visibility (whether or not visibility is good) in the surrounding information. The evaluation unit 23 may decide that it is the safe situation and evaluate that the degree of influence is low when the visibility is good, and may determine that it is a relatively dangerous situation and evaluate that the degree of influence is high when the visibility is poor.

The decision unit 24 decides a timing at which the provision source server is switched from the server A 30a to the server B 30b on the basis of the evaluation result obtained by the evaluation unit 23 as described above. The timing decided by the decision unit 24 is not limited thereto as long as it is a timing with a low degree of influence as described for the decision unit 1b.

A simple example of the decision method in a case in which both the communication packet information and the surrounding information are adopted as the evaluation target information will be described. For example, when both the evaluation result of the communication packet information and the evaluation result of the surrounding information indicate a situation in which there is no problem even if the server switching process is executed (a situation in which the degree of influence is low), the decision unit 24 may decide that the server switching process is executed at that timing. On the other hand, for example, when the evaluation result of at least one of the communication packet information and the surrounding information indicates a problematic situation (a situation in which the degree of influence is evaluated as being high), the decision unit 24 may decide that the server switching process is not executed at that timing.

Here, in a case in which both the communication packet information and the surrounding information are adopted as the evaluation target information, the evaluation result is assumed to be output for each piece of information, but the evaluation unit 23 may output the evaluation result in which both pieces of information are considered.

In a case in which both the current information and the prediction information are used as the evaluation target information, the following decision may be made. That is, for example, the server switching process may not be executed in a case in which the degree of influence is evaluated as being high for at least one piece of information, and the server switching process may be executed in a case in which the degree of influence is evaluated as being low for both pieces of information.

Here, in a case in which both the current information and the future information are adopted as the evaluation target information, the evaluation result is assumed to be output for each piece of information, but the evaluation unit 23 may output the evaluation result in which both pieces of information are considered.

The instruction unit 25 gives an instruction to switch the provision source server from the server A 30a to the server B 30b at the timing decided by the decision unit 24. This instruction is similar to the one described for the instruction unit 1c. That is, this instruction may be an instruction to cause the service, which is being provided from the server A 30a to the mobile object 50, to be provided from the server B 30b. For example, in a case in which the emergency alert service is being provided to the mobile object 50 via the server A 30a, the instruction unit 25 gives an instruction to activate an application of the emergency alert service already disposed in the server B 30b serving as the switching destination. That is, this instruction may be an instruction to cause the service related to the service, which is being provided from the server A 30a to the mobile object 50, to be provided from the server B 30b. The examples of the instruction destination are also similar to those described for the instruction unit 1c, and a specific example will be described later with reference to FIG. 6.

With this instruction, the mobile object 50 is able to receive the service, which is being received from the server A 30a via the network N, from the server B 30b via the network N.

Next, a process example in the management system 100 of FIG. 4 will be described with reference to FIG. 6. FIG. 6 is a schematic diagram for describing a process example in the management system 100.

As illustrated in FIG. 6, the management system 100 may include a management apparatus 20 and a 5th generation core network (5GC) 40, which is a core network of a 5th generation mobile communication system (5G system). The 5GC 40 is a network used as part of the network N. The server A 30a, the server B 30b, and the 5GC 40 are wirelessly connected to the mobile object 50 via a wireless base station (gNB: g Node B) or a wireless relay station.

For example, as illustrated in FIG. 6, in the management system 100, the management apparatus 20 may be connected to the 5GC 40, and user plane functions (UPF) 41a and 41b may be connected to the 5GC 40. The UPFs 41a and 41b are nodes which are in charge of processing user plane data in the 5G system, and may be configured with dedicated hardware apparatuses. The UPF 41a and the UPF 41b are connected to a gNB 42a and a gNB 42b which are examples of a wireless base station or a wireless relay station, and are connected to the server A 30a and the server B 30b, respectively.

In the mobile object 50, the communication apparatus 55 may perform wireless communication with the gNB 42a to communicate with the server A 30a, and be provided with the service from the server A 30a. Even in a case in which the vehicle information or the like acquired by the mobile object 50 is necessary for this provision, the vehicle information or the like may be transmitted from the mobile object 50 to the server A 30a.

Here, the gNB 42a can allocate wireless communication resources (base station resources) to the mobile object 50 or other mobile objects in response to an instruction given from the server A 30a, the 5GC 40, other systems in the network N, the management apparatus 20, or the like, and perform wireless communication. The mobile object 50 or other mobile object can perform communication with the server A 30a which is a service provision source via the allocated wireless communication resources, and receive a desired service. Similar description applies to a case in which the mobile object 50 or the like receives a service from the server B 30b.

Further, in the mobile object 50, the communication apparatus 55 performs wireless communication with the gNB 42a so that the surrounding information or the analysis target information acquired by the mobile object 50 can be transmitted to the management apparatus 20 via the 5GC 40, but a transmission path of the surrounding information or the analysis target information is not limited. Although the communication between the mobile object 50 and the server A 30a or the management apparatus 20 has been described, similar description applies to communication between the mobile object 50 and the server B 30b or the management apparatus 20.

Further, the spot information transmission apparatuses 31a and 31b can be connected to the gNB 42a and the gNB 42b, respectively, connected to the UPF 41a and the UPF 41b, respectively, or directly connected to the server A 30a and the server B 30b. As a result, the spot information transmission apparatuses 31a and 31b can transmit the surrounding information or the analysis target information acquired at the spot A and the spot B to the management apparatus 20 via the 5GC 40, respectively.

The management apparatus 20 according to the present example embodiment can decide the server switching timing in the following order. First, the management apparatus 20 receives the surrounding information or the analysis target information via the 5GC 40 or directly from the mobile object 50 (step i). In the case of reception via the 5GC 40, for example, the management apparatus 20 may acquire the surrounding information or the analysis target information managed on the 5GC 40 side.

The reception of step i may be periodically performed, or may be performed as a result of an information request from the management apparatus 20 at the stage at which evaluation is performed. Further, in a case in which information is received from the 5GC 40, the management apparatus 20 may transmit a request, for example, to a NEF for providing network functions (NFs) constituting the 5GC 40 to the outside, and receive the information. Here, the NEF stands for a network exposure function. The management apparatus 20 may request the NEF to subscribe to the position information of the mobile object 50, and make a request to give a notification of the latest position information of the mobile object 50 from the NEF to the management apparatus 20, for example, at a timing when a connected wireless base station of the mobile object 50 is changed. The management apparatus 20 may use the acquired position information of the mobile object 50 when selecting the switching destination server.

Here, the management apparatus 20 may receive a video acquired by the camera 32a or information extracted from the video as the surrounding information or the analysis target information directly from the spot information transmission apparatus 31a or via the 5GC 40. Further, since the mobile object 50 is moving from the spot A to the spot B, instead of the information of the spot A or together with the information of the spot A, the information of the spot B may be received from the spot information transmission apparatus 31b as the surrounding information or the analysis target information.

After the process of step i, the management apparatus 20 requests the server A 30a to provide the communication packet information in the communication between the mobile object 50 and the server A 30a (step ii), and receives the communication packet information from the server A 30a as a response (step iii). Since the server A 30a can perform communication with the mobile object 50 at least intermittently and obtain the communication packet information, in step iii, the management apparatus 20 can return the communication packet information to the management apparatus 20 and then receive the communication packet information.

In a case in which the communication packet information is constantly exchanged between the management apparatus 20 and the server A 30a, the inquiry process of steps ii and iii need not to be executed again for evaluation. However, the order of step i and step ii is not limited, and at least one of step i and steps ii and iii can be executed.

Next, the management apparatus 20 decides the timing of the server switching process (step iv). Schematically, in step iv, in a case in which the analysis target information is received, the management apparatus 20 analyzes the analysis target information, obtains the surrounding information, and evaluates the degree of influence on the basis of the evaluation target information which is one or both of the surrounding information acquired or obtained by the analysis and the communication packet information acquired. The degree of influence is the degree of influence of the server switching process exerted on the service. In step iv, next, the management apparatus 20 decides the timing of the server switching process on the basis of the evaluation result.

Subsequently to step iv, the management apparatus 20 instructs the 5GC 40 to perform the server switching process at the switching timing decided that the degree of influence by the server switching process is low (or there is no degree of influence) (step v). Specifically, the management apparatus 20 instructs the NEF of the 5GC 40 to perform the server switching. For example, the NEF controls routing in the network, and performs setting in such a way that the communication packets flow to different servers even though the IP addresses are the same (routing is changed in such a way that the communication packets flow to desired servers).

Here, the instruction destination is not limited to the 5GC 40 which is an example of a core network system of a wireless communication network. Further, the instruction destination of the instruction unit 25 varies depending on a system configuration in which the service is being provided to the mobile object 50, a relationship on a system between the server A 30a and the server B 30b, or the like. As another example of the 5GC 40, for example, a management server that manages the server A 30a, a management server that manages the server B 30b, a management server that manages the server A 30a and the server B 30b, or the like may be the instruction destination. These management servers can manage, for example, information used when the server A 30a and the server B 30b provide the services, but may be configured to be able to provide the services to the mobile object 50 in addition to the management function.

With this instruction, the mobile object 50 can receive the service, which is being received from the server A 30a, from the server B 30b.

Although the details of steps of FIG. 6 have already been described, various examples of the evaluation target information, the evaluation result, and the switching timing to be decided will be specifically described below. As described above, the evaluation target information is used when the evaluation unit 23 evaluates the influence of the server switching process exerted on the service (mainly application communication) provided to the mobile object 50. There are two types of evaluation target information: a case in which the communication packet information is adopted and a case in which the surrounding information serving as information of the real world is adopted. As described above, these two types can be used together.

An example of using the communication information will be described.

The timing at which communication is not occurring is a timing at which communication packets are not occurring. Therefore, the evaluation unit 23 evaluates, on the basis of the acquired communication packet information, the timing at which the communication packets are not occurring as having a low degree of influence, and evaluates the timing at which the communication packets are occurring as having a high degree of influence. In that case, the decision unit 24 decides the switching timing so that the server switching process is executed at the timing when the degree of influence is evaluated as being low. In a case in which the current information is used, the switching timing is decided depending on whether communication is occurring or not at that time point.

For example, in a case in which the communication packet information indicating that the application has a low degree of importance (regardless of safe driving) even during communication is acquired, a time point at which the acquired communication packet information is evaluated may be decided as the switching timing. For example, in a case in which the communication packet information indicating that the application performing communication is an entertainment application is acquired, a time point at which the acquired communication packet information is evaluated is decided as the switching timing. That is, although communication is occurring, in a case in which the communication packets are communication packets for music distribution or the like such as entertainment distribution, for example, the evaluation unit 23 evaluates that the degree of influence is low because the degree of importance is lower than communication related to life (communication related to safe driving). In this case, the decision unit 24 may decide a time point at which the evaluation is performed as the switching timing.

On the other hand, for example, in a case in which the communication packet information indicating that the application performing communication is an emergency alert-related application is acquired, it relates to safe driving. Therefore, in this case, the degree of influence is evaluated as being high, and the switching timing is decided so that the server switching process is not executed at the time point of the evaluation.

Further, even in an application for providing a single service, there are a situation in which communication with a low degree of importance is being performed and a situation in which communication with a high degree of importance is being performed, and the switching timing may be decided by evaluating the degree of influence in accordance with these situations. For example, in a case in which the communication packet information indicating the communication packet with a low degree of importance (within a single application) is acquired even during communication, the degree of influence is evaluated as being low, and the switching timing is decided in such a way that the server switching process is executed at the time point of the evaluation. For example, in a case in which the application is H.264 video distribution, the I frame for transmitting all pieces of information is more important than the P/B frame for transmitting only the difference information. Therefore, in this case, for example, a timing at which the P frame and the B frame are distributed is evaluated as having a low degree of influence, and the switching timing is decided such that the server switching process is executed at the distribution timing of at least one of the P frame and the B frame. Further, even for a single application that provides a single service, since there are important information and unimportant information, it is desirable to evaluate the degree of influence on the basis of the communication packet information and decide the switching timing on the basis of the evaluation result.

Further, for example, the prediction information obtained by predicting a future communication packet occurrence situation such as a next packet occurrence timing may be used as the communication packet information. In this case, on the basis of the prediction information, evaluation of the degree of influence is evaluated (in this case, the degree of influence is evaluated as being low) and decision of the switching timing are performed in such a way that the server switching process is executed at a timing at which communication is predicted not to occur.

Further, the server switching process accompanies a period of time during which communication is interrupted and a period of time during which the service is temporarily interrupted, and in a case in which the management system 20 has a function of determining these periods of time, the degree of influence may be evaluated on the basis of the determination result. For example, in a case in which it is predicted that the communication packets for providing the service are occurring within a determined communication disconnection period of time, the evaluation unit 23 may evaluate that there is a degree of influence. In this case, the decision unit 24 may decide the switching timing while avoiding the timing at which it is evaluated that there is a degree of influence.

An example of using the surrounding information will be described.

In a case in which the surrounding information is used, the degree of influence is evaluated on the basis of the surrounding information, and a timing at which an actual harm is considered to be small even if the communication is temporarily interrupted is decided as the switching timing from the surrounding information. For example, in a case in which information indicating that the driving speed is equal to or lower than a predetermined speed or information indicating that the vehicle is temporarily parked is obtained, it may be determined that the mobile object 50 is moving slowly or is temporarily parked. Further, the absence of an obstacle (other vehicles, a pedestrian, or the like) in the surrounding area may be analyzed from information obtained from the cameras (roadside cameras) 32a and 32b or a camera mounted on the mobile object 50.

Therefore, in a case in which the acquired surrounding information indicates a case in which the vehicle is temporarily parked or no obstacle exists in the surrounding area, the evaluation unit 23 evaluates that the degree of influence is low, and the decision unit 24 decides the time point at which the evaluation is performed as the switching timing. Similarly, also in a case in which the surrounding information indicates that the vehicle is traveling on a monotonous road, or in a case in which the visibility is good such as a case in which it is not raining or a case in which it is the daytime, the degree of influence may be evaluated as being low, and the time point at which the evaluation is performed may be decided as the switching timing. Further, the surrounding information may be used as the prediction information, and for example, switching of signal light may be predicted from information or the like obtained from the mobile object 50 or an infrastructure system, and the degree of influence may be evaluated using the predicted information. In that case, for example, the evaluation unit 23 can evaluate that the degree of influence is high in a case in which the current red light is likely to be switched to the green light within a predetermined period of time. The decision unit 24 may decide the switching timing by excluding the timing with the high degree of influence.

The order of the decision process of the switching timing has been described above as an example, but for example, the functions of the management apparatus 20 may be distributed in such a way that the functions of the evaluation unit 23 are distributed to the management apparatus 20 and the server A 30a serving as the switching source server, and thus the order of the process is changed.

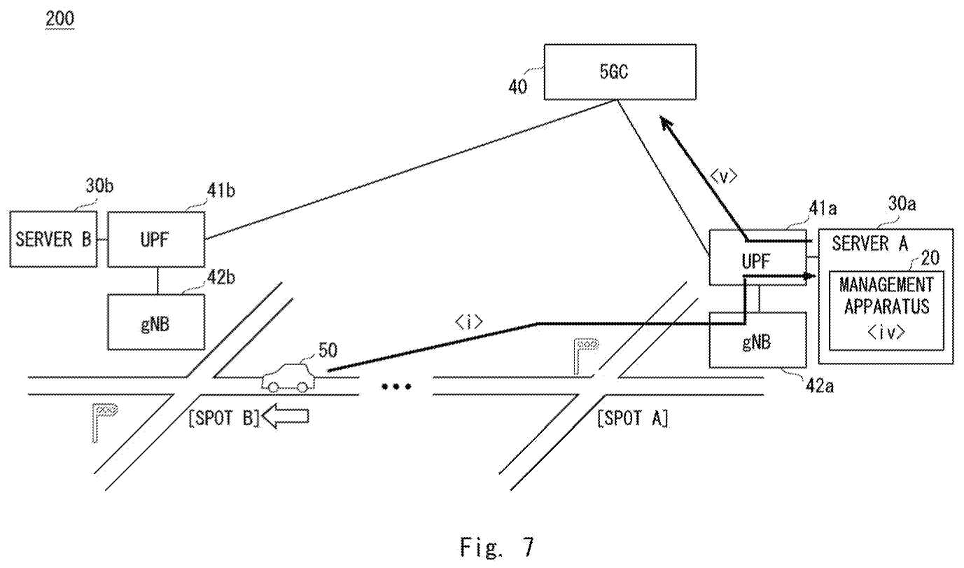

Further, as illustrated in FIG. 7, the management apparatus 20 of FIG. 6 nay be incorporated in the server A 30a. FIG. 7 is a schematic diagram for explaining still another configuration example of the management system 1 of FIG. 1 and a process example thereof.

In the example of FIG. 7, since the management apparatus 20 is disposed in the server A 30a, the process of steps ii and iii of FIG. 6 is performed inside the server A 30a, and the inquiry process to other apparatuses becomes unnecessary. Other processing examples are similar to the example of FIG. 6. Here, FIG. 7 illustrates an example in which the management apparatus 20 receives the surrounding information or the analysis target information from the mobile object 50 via the gNB 42a and the UPF 41a in the process of step i. Of course, also in the example of FIG. 7, the path through which the management apparatus 20 may receive the surrounding information or the analysis target information is not limited.

As in this example, the management apparatus 20 may be disposed in the provision source server, but may be disposed in, for example, a management server that manages (centralized management or the like) the provision source server. The provision source server here is a server that provides the service to the mobile object 50 at the time point of evaluation, and here refers to the server A 30a. Further, the management apparatus 20 may be disposed in a management node such as a switching destination server or a management server that manages the switching destination server.

### Second Example Embodiment

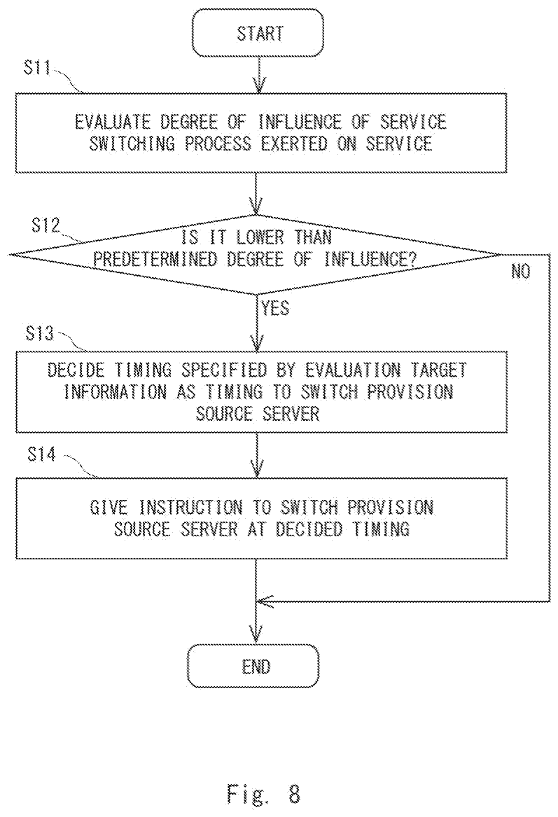

A second example embodiment will be described with reference to FIG. 8, focusing on differences from the first example embodiment, but various examples described in the first example embodiment can be applied in the present example embodiment. FIG. 8 is a flowchart for describing an example of a management method in a management system according to the present example embodiment.

The decision unit 24 (or the decision unit 1c) according to the present example embodiment decides a timing at which the evaluation result of the evaluation unit 23 is lower than a predetermined degree of influence as the timing for switching the provision source server in the first example embodiment. Further, in the first example embodiment, it is evaluated only whether the degree of influence is high or low (evaluated in two stages), but in the present example embodiment, the evaluation unit 23 may output evaluation results of three or more stages.

A process example of this management method will be described. First, the evaluation unit 23 executes an evaluation process of evaluating the degree of influence of the server switching process exerted on the service (step S11). Next, the decision unit 24 decides whether or not the evaluation result of the evaluation process indicates that the degree of influence is lower than a predetermined degree of influence (step S12), and the process ends in the case of NO.

In the case of YES in step S12, the decision unit 24 decides a timing specified from the evaluation target information, regardless of the evaluation result based on either the current information or the prediction information, as the switching timing for switching the server A 30a (step S13). If the evaluation target information is the current information, in a case in which the evaluation result lower than the predetermined degree of influence is obtained, the server switching process is performed at the obtained timing, and if the evaluation target information is the prediction information, the server switching process is performed at a prediction date and time. Further, regardless of whether the evaluation target information is the current information or the prediction information, in step S13, the timing at which the determination of YES is performed in step S12 may be decided as the switching timing. As a result, even in the case of the evaluation using the prediction information, the server switching process may be executed in advance.

The instruction unit 25 gives an instruction to switch from the server A 30a to the server B 30b at the switching timing decided in the decision process (step S14). The server switching process is executed on the basis of the instruction of step S14. The process of steps S11 to S14 can be executed at predetermined intervals, but is not limited thereto, and for example, the process of steps S11 to S14 may be executed on the basis of a predetermined standard in such a way that the process is not performed for a certain period immediately after the server switching processing is executed.

According to the present example embodiment, in addition to the effects of the first example embodiment, in a case in which the degree of influence is higher than the predetermined degree of influence, the timing is not set as the switching timing, and for example, the switching timing can be delayed until the next or subsequent evaluation. Further, according to the present example embodiment, it is possible to prevent or omit the instruction process in a situation in which the degree of influence is higher than a predetermined degree of influence.

### Third Example Embodiment

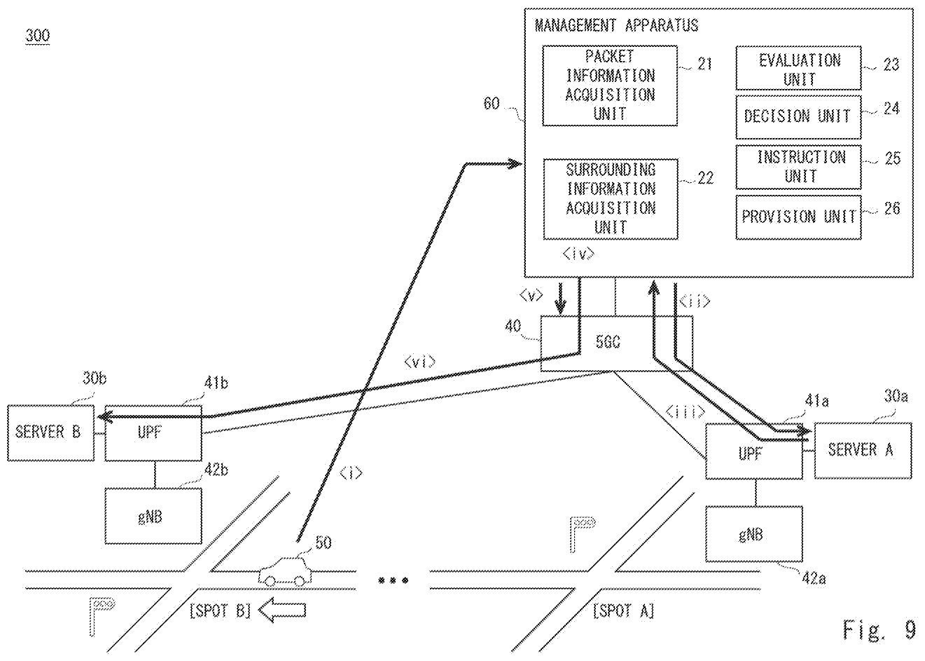

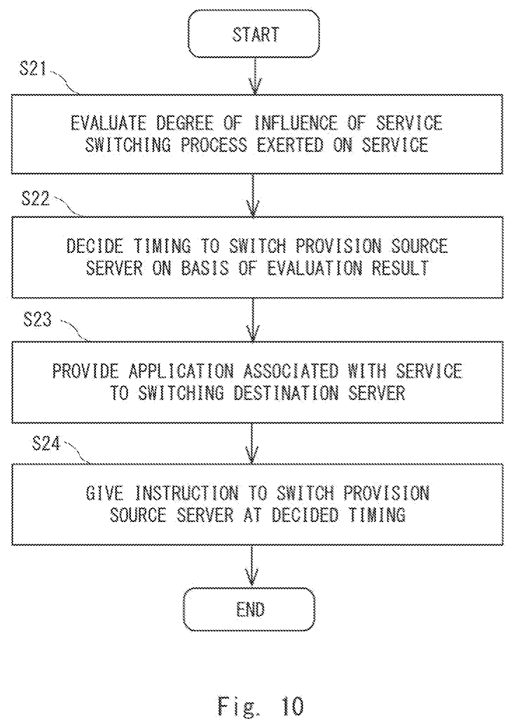

A third example embodiment will be described with reference to FIGS. 9 and 10, focusing on differences from the first example embodiment, but various examples described in the first and second example embodiments can be applied in the present example embodiment. First, a management system according to the present example embodiment will be described with reference to FIG. 9. FIG. 9 is a schematic diagram for explaining a management system according to the present example embodiment and a process example thereof.

As illustrated in FIG. 9, a management system 300 according to the present example embodiment includes a management apparatus 60 having a configuration in which the management apparatus 20 further includes a provision unit 26 in the management system 100 illustrated in FIGS. 4 and 6. Further, the management apparatus 60 may be implemented in such a way that the functions of the respective units are distributed to separate apparatuses, and a distribution method thereof is not limited. For example, the management apparatus 60 may be configured with an apparatus including the packet information acquisition unit 21, an apparatus including the surrounding information acquisition unit 22, an apparatus including the evaluation unit 23, an apparatus including the decision unit 24, an apparatus including the instruction unit 25, and an apparatus including the provision unit 26.

The provision unit 26 provides an application for providing the service which is being provided from the server A 30a to the server (the server B 30b in this example) serving as the switching destination in response to the instruction from the instruction unit 25. For example, in a case in which the emergency alert service is provided to the mobile object 50 via the server A 30a, the provision unit 26 provides the application of the emergency alert service to the server B 30b serving as the switching destination so that the application can be activated. Alternatively, the provision unit 26 provides the server serving as the switching destination with application state information indicating an operation state in the application and an operation state related to provision of the service to the mobile object 50. Further, in a case in which the application is provided, the provision unit 26 may provide the application state information together in the application or provide the application state information included in the application.

The application state information is information indicating an operation state of the service provided to the mobile object 50 by the application program. For example, the application state information may be information such as a parameter which is managed and referred to by the application when the service is provided to the mobile object 50 among operation states in the application, and may be used as session information of the application. For example, in a case in which the emergency alert service is being provided to the mobile object 50 via the server A 30a, the provision unit 26 may provide the following application state information. That is, the provision unit 26 may provide information for adding, as the service provision destination, the mobile object 50 to the application of the emergency alert service already disposed in the server B 30b serving as the switching destination. As described above, the application state information is information specific to the mobile object 50 (information specific to the user of the mobile object 50), but in particular, it is desirable to set the application state information as the information specific to the mobile object 50 immediately before the switching timing of the server switching process. As described above, the application state information provided by the provision unit 26 is set as the information immediately before the server switching process is executed, and thus the service can be continuously provided to the mobile object 50 without giving discomfort to the user of the mobile object 50 before and after the server switching process.

In the example of FIG. 9, since the management apparatus 60 includes the provision unit 26, the provision unit 26 provides the application or the application state information to the server B 30b after the process of steps i to v of FIG. 6 or between steps iv and v (step vi). Other processing examples are similar to the example of FIG. 6.

Regardless of the path of the provision, for example, the provision may be performed via the network N in FIG. 4, or via the 5GC 40 and the UPF 41b in FIG. 6.

It is also possible to assume a system in which the application for providing the service to the server B 30b of the switching destination does not exist or is caused not to exist in terms of operation at the time of actual operation. Even in this case, in the present example embodiment, the application for providing the service can be provided to the server B 30b of the switching destination, and the server B 30b can provide the service to the mobile object 50. In the server B 30b, it is desirable to expand data of the application obtained from the management apparatus 60 and launch it in a state in which the service can be provided.

Further, in the configuration example of FIG. 9, the application or the application state information is provided from the management apparatus 60 to the server B 30b serving as the switching destination server, but as an operation, the provision source is not limited to the management apparatus 60 regardless of the transfer path. For example, the switching source server may transfer the application being operated in the switching source server or only the application state information thereof to the switching destination server. For example, in a case in which the application is being operated in a container of a virtualization technology, the container (application container) may be moved from the server A 30a to the server B 30b.

Further, it is also possible to predict a time at which the switching instruction is given in consideration of a time of the application launch process in the server B 30b of the switching destination and to provide the application or the application state information in advance. For example, when the switching timing is decided by the decision unit 24, the application or the application state information may be provided simultaneously with or before the server switching instruction. Even in a case in which this pre-provision is adopted, the above-described transfer can be used. For example, such combination can be implemented in a situation in which a large number of the same applications are held in a server included in the management system 300 and the applications are provided to a plurality of mobile objects. Specifically, the management apparatus 60 may transfer the application from the server (not limited to the server A 30a) in which the application becomes unnecessary due to the switching to the server B 30b that will be necessary in the future.

Next, an example of a management method in the management system 300 of FIG. 9 will be described with reference to FIG. 10. FIG. 10 is a flowchart for explaining an example of the management method in the management system 300.

In this management method, first, the evaluation unit 23 executes the evaluation process of evaluating the degree of influence of the server switching process exerted on the service (step S21). Next, the decision unit 24 executes the decision process of deciding the timing to switch the provision source server on the basis of the evaluation result in the evaluation process (step S22).

Next, the provision unit 26 provides the application to the switching destination server (the server B 30b in this example) for the service being provided to the mobile object 50 (step S23). In step S23, only the application state information may be provided instead of or in addition to the application. Then, the instruction unit 25 gives an instruction to switch the provision source server at the switching timing decided in the decision process (step S25). The server switching process is executed on the basis of the instruction of step S25.

The process of steps S21 to S24 can be executed at predetermined intervals, but is not limited thereto, and for example, the process of steps S21 to S24 may be executed on the basis of a predetermined standard in such a way that the process is not performed for a certain period immediately after the server switching processing is executed.

As described above, in the present example embodiment, in addition to the effects of the first and second example embodiments, it is possible to provide the service equivalent to that of the switching source server from the switching destination server as the application or the application state information is provided to the switching destination server. Further, in the present example embodiment, since the application can be provided to the server at a necessary timing, it is possible to efficiently utilize finite calculation resources and storage resources in the server as compared with a case in which the application is constantly mounted on the server.

### Others

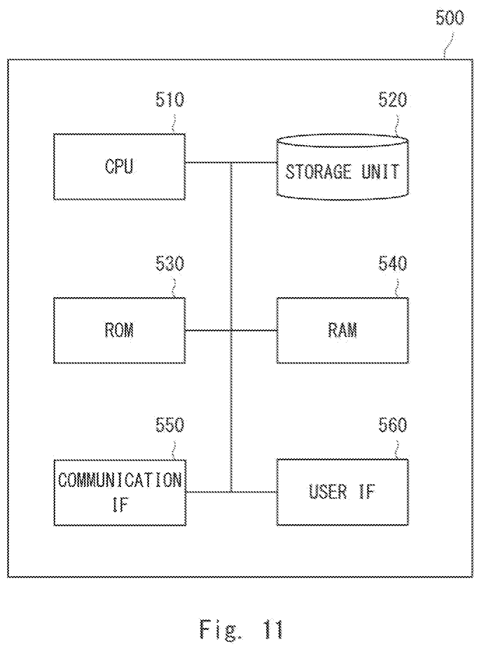

In the present disclosure, the apparatuses such as the management apparatus, the server, and the mobile communication terminal apparatus may be configured as a computer apparatus. FIG. 11 is a block diagram illustrating an example of a configuration of a computer apparatus. A computer apparatus 500 includes, as a control unit, a central processing unit (CPU) 510, a storage unit 520, a read only memory (ROM) 530, and a random access memory (RAM) 540. Further, the computer apparatus 500 may include a communication interface (IF) 550 and a user interface 560.

The computer apparatus 500 may be used as any of the management apparatuses 2, 20, and 60. Further, the computer apparatus 500 may be used as a server (for example, the server A 30a or the server B 30b) that provides the service, and may be used as the spot information transmission apparatus 31a or 31b. Further, the computer apparatus 500 may be used as an information processing apparatus mounted on the mobile object 50, and may be used as the mobile communication terminal apparatus brought into the mobile object 50.

The communication interface 550 is an interface for connecting the computer apparatus 500 to a communication network through wired communication means, wireless communication means, or the like. The user interface 560 may include, for example, a display unit such as a display. Further, the user interface 560 may include input units such as a keyboard, a mouse, and a touch panel.

The storage unit 520 is an auxiliary storage device that can hold various types of data. The storage unit 520 need not to be necessarily part of the computer apparatus 500 and may be an external storage device or a cloud storage connected to the computer apparatus 500 via a network.

The ROM 530 is a non-volatile storage device. For example, a semiconductor storage device such as a flash memory having a relatively small capacity may be used for the ROM 530. A program that is executed by the CPU 510 may be stored in the storage unit 520 or the ROM 530. The storage unit 520 or the ROM 530 stores various programs for implementing the functions of the respective units in the computer apparatus 500.

The program includes a group of instructions (or software codes) for causing a computer to perform one or more functions that have been described in the example embodiments when the program is read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or other memory technology, a compact disc (CD), a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer-readable medium or a communication medium. As an example and not by way of limitation, the transitory computer-readable medium or the communication medium includes propagated signals in electrical, optical, acoustic, or any other form.

The RAM 540 is a volatile storage device. As the RAM 540, various types of semiconductor memory devices such as a dynamic random access memory (DRAM) or a static random access memory (SRAM) may be used. The RAM 540 may be used as an internal buffer for temporarily storing data or the like. The CPU 510 develops a program, stored in the storage unit 520 or the ROM 530, in the RAM 540, and executes the developed program. The functions of the respective units in the computer apparatus 500 may be implemented by the CPU 510 executing the program. The CPU 510 may include an internal buffer in which data or the like can be temporarily stored.

Although example embodiments according to the present disclosure have been described above in detail, the present disclosure is not limited to the above-described example embodiments, and the present disclosure also includes those that are obtained by making changes or modifications to the above-described example embodiments without departing from the spirit of the present disclosure.

For example, some or all of the above-described example embodiments may be described as the following supplementary notes, but the present disclosure is not limited to the following supplementary notes.

### (Supplementary Note 1)

A management system including:
an evaluation means for evaluating a degree of influence of a server switching process of switching a provision source server of a service for a mobile object, which is exerted on the service;
a decision means for deciding a timing to switch the provision source server on the basis of an evaluation result of the evaluation means; and
an instruction means for giving an instruction to switch the provision source server at the timing decided by the decision means.

### (Supplementary Note 2)

The management system according to supplementary note 1, wherein the decision means decides a timing at which the evaluation result is lower than a predetermined degree of influence as the timing to switch the provision source server.

### (Supplementary Note 3)

The management system according to supplementary note 1 or 2, wherein the evaluation means performs evaluation on the basis of evaluation target information including at least one of communication packet information for communication between the provision source server and the mobile object and surrounding information indicating a surrounding environment of the mobile object.

### (Supplementary Note 4)

The management system according to supplementary note 3, wherein the surrounding information includes at least one piece of information or information analyzed on the basis of at least one piece of information among information acquired from the mobile object, information acquired from another mobile object located around the mobile object, information acquired from an information acquisition device installed in a path on which the mobile object moves, and information acquired from an information provision server.

### (Supplementary Note 5)

The management system according to supplementary notes 3 or 4, wherein the evaluation target information includes at least one of current information at a time point at which the evaluation is executed by the evaluation means and prediction information obtained by predicting information of a future from the time point at which the evaluation is executed by the evaluation means.

### (Supplementary Note 6)

The management system according to any one of supplementary notes 1 to 5, further comprising, a provision means for providing an application program for providing the service or application state information indicating an operation state of the service which is provided to the mobile object by the application program to a server serving as a switching destination in response to the instruction.

### (Supplementary Note 7)

The management system according to any one of supplementary notes 1 to 6, further comprising, a management apparatus including the evaluation means, the decision means, and the instruction means,
wherein the management apparatus is included in the provision source server or a server that manages the provision source server.
   (Supplementary Note 8) A management apparatus including:
an evaluation means for evaluating a degree of influence of a server switching process of switching a provision source server of a service for a mobile object, which is exerted on the service;
a decision means for deciding a timing to switch the provision source server on the basis of an evaluation result of the evaluation means; and
an instruction means for giving an instruction to switch the provision source server at the timing decided by the decision means.

### (Supplementary Note 9)

The management apparatus according to supplementary note 8, wherein the decision means decides a timing at which the evaluation result is lower than a predetermined degree of influence as the timing to switch the provision source server.

### (Supplementary Note 10)

The management apparatus according to supplementary note 8 or 9, wherein the evaluation means performs evaluation on the basis of evaluation target information including at least one of communication packet information for communication between the provision source server and the mobile object and surrounding information indicating a surrounding environment of the mobile object.

### (Supplementary Note 11)

The management apparatus according to supplementary note 10, wherein the surrounding information includes at least one piece of information or information analyzed on the basis of at least one piece of information among information acquired from the mobile object, information acquired from another mobile object located around the mobile object, information acquired from an information acquisition device installed in a path on which the mobile object moves, and information acquired from an information provision server.

### (Supplementary Note 12)

The management apparatus according to supplementary notes 10 or 11, wherein the evaluation target information includes at least one of current information at a time point at which the evaluation is executed by the evaluation means and prediction information obtained by predicting information of a future from the time point at which the evaluation is executed by the evaluation means.

### (Supplementary Note 13)

The management apparatus according to any one of supplementary notes 8 to 12, further comprising, a provision means for providing an application program for providing the service or application state information indicating an operation state of the service which is provided to the mobile object by the application program to a server serving as a switching destination in response to the instruction.

### (Supplementary Note 14)

The management apparatus according to any one of supplementary notes 8 to 13, wherein the management apparatus is included in the provision source server or a server that manages the provision source server.

### (Supplementary Note 15)

A management method including:
performing an evaluation process of evaluating a degree of influence of a server switching process of switching a provision source server of a service for a mobile object, which is exerted on the service;
performing a decision process of deciding a timing to switch the provision source server on the basis of an evaluation result of the evaluation process; and
giving an instruction to switch the provision source server at the timing decided by the decision process.

### (Supplementary Note 16)

The management method according to supplementary note 15, wherein the decision process includes deciding a timing at which the evaluation result is lower than a predetermined degree of influence as the timing to switch the provision source server.

### (Supplementary Note 17)

The management method according to supplementary note 15 or 16, wherein the evaluation process includes performing evaluation on the basis of evaluation target information including at least one of communication packet information for communication between the provision source server and the mobile object and surrounding information indicating a surrounding environment of the mobile object.

### (Supplementary Note 18)

The management method according to supplementary note 17, wherein the surrounding information includes at least one piece of information or information analyzed on the basis of at least one piece of information among information acquired from the mobile object, information acquired from another mobile object located around the mobile object, information acquired from an information acquisition device installed in a path on which the mobile object moves, and information acquired from an information provision server.

### (Supplementary Note 19)

The management method according to claim 17 or 18, wherein the evaluation target information includes at least one of current information at a time point at which the evaluation is executed by the evaluation process and prediction information obtained by predicting information of a future from the time point at which the evaluation is executed by the evaluation process.

### (Supplementary Note 20)

The management method according to any one of claims 15 to 19, further comprising, providing an application program for providing the service or application state information indicating an operation state of the service which is provided to the mobile object by the application program to a server serving as a switching destination in response to the instruction.

### (Supplement 21)

The management method according to any one of supplementary notes 15 to 20, wherein the evaluation process, the decision process, and the instruction are executed by the provision source server or a server that manages the provision source server.

### (Supplementary Note 22)

A program causing a computer to perform a management process of:
performing an evaluation process of evaluating a degree of influence of a server switching process of switching a provision source server of a service for a mobile object, which is exerted on the service;
performing a decision process of deciding a timing to switch the provision source server on the basis of an evaluation result of the evaluation process; and
giving an instruction to switch the provision source server at the timing decided by the decision process.

### (Supplementary Note 23)

The program according to supplementary note 22, wherein the decision process includes deciding a timing at which the evaluation result is lower than a predetermined degree of influence as the timing to switch the provision source server.

### (Supplementary Note 24)

The program according to supplementary note 22 or 23, wherein the evaluation process includes performing evaluation on the basis of evaluation target information including at least one of communication packet information for communication between the provision source server and the mobile object and surrounding information indicating a surrounding environment of the mobile object.

### (Supplementary Note 25)

The program according to supplementary note 24, wherein the surrounding information includes at least one piece of information or information analyzed on the basis of at least one piece of information among information acquired from the mobile object, information acquired from another mobile object located around the mobile object, information acquired from an information acquisition device installed in a path on which the mobile object moves, and information acquired from an information provision server.

### (Supplementary Note 26)

The process according to claim 24 or 25, wherein the evaluation target information includes at least one of current information at a time point at which the evaluation is executed by the evaluation process and prediction information obtained by predicting information of a future from the time point at which the evaluation is executed by the evaluation process.

### (Supplementary Note 27)

The program according to any one of claims 22 to 26, further including, providing an application program for providing the service or application state information indicating an operation state of the service which is provided to the mobile object by the application program to a server serving as a switching destination in response to the instruction.

### (Supplementary Note 28)

The program according to any one of supplementary notes 22 to 27, wherein the computer is the provision source server or a server that manages the provision source server.

### REFERENCE SIGNS LIST

1, 100, 200, 300 MANAGEMENT SYSTEM
1a, 23 EVALUATION UNIT
1b, 24 DECISION UNIT
1c, 25 INSTRUCTION UNIT
2, 20, 60 MANAGEMENT APPARATUS
21 PACKET INFORMATION ACQUISITION UNIT
22 SURROUNDING INFORMATION ACQUISITION UNIT
22a ANALYSIS UNIT
26 PROVISION UNIT
30a SERVER A
30b SERVER B
31a, 31b SPOT INFORMATION TRANSMISSION APPARATUS
32a, 32b CAMERA
40 5GC
41a, 41b UPF
42a, 42b gNB
51 SURROUNDING MONITORING SENSOR
52 VEHICLE SENSOR
53 VEHICLE CONTROL ECU
54 AUTOMATIC DRIVING ECU
55 COMMUNICATION APPARATUS
56 SERVICE PROVISION APPARATUS
50 MOBILE OBJECT
500 COMPUTER APPARATUS
510 CPU
520 STORAGE UNIT
530 ROM
540 RAM
550 COMMUNICATION INTERFACE
560 USER INTERFACE

What is claimed is:

1. A management system comprising:
at least one memory storing instructions; and
at least one processor configured to execute the instructions to do management processing, the management processing includes:
evaluating a degree of influence of a server switching process of switching a provision source server of a service for a mobile object, which is exerted on the service;
deciding a timing to switch the provision source server on the basis of an evaluation result of the evaluating; and
giving an instruction to switch the provision source server at the timing decided by the deciding.

2. The management system according to claim 1, wherein the deciding is deciding a timing at which the evaluation result is lower than a predetermined degree of influence as the timing to switch the provision source server.

3. The management system according to claim 1, wherein the evaluating performs evaluation on the basis of evaluation target information including at least one of communication packet information for communication between the provision source server and the mobile object and surrounding information indicating a surrounding environment of the mobile object.

4. The management system according to claim 3, wherein the surrounding information includes at least one piece of information or information analyzed on the basis of at least one piece of information among information acquired from the mobile object, information acquired from another mobile object located around the mobile object, information acquired from an information acquisition device installed in a path on which the mobile object moves, and information acquired from an information provision server.

5. The management system according to claim 3, wherein the evaluation target information includes at least one of current information at a time point at which the evaluation is executed by the evaluating and prediction information obtained by predicting information of a future from the time point at which the evaluation is executed by the evaluating.

6. The management system according to claim 1, wherein the management processing further includes providing an application program for providing the service or application state information indicating an operation state of the service which is provided to the mobile object by the application program to a server serving as a switching destination in response to the instruction.

7. The management system according to claim 1, further comprising, a management apparatus performs the evaluating, the deciding, and the giving,
wherein the management apparatus is included in the provision source server or a server that manages the provision source server.

8. A management apparatus comprising:
at least one memory storing instructions; and
at least one processor configured to execute the instructions to do management processing, the management processing includes:
evaluating a degree of influence of a server switching process of switching a provision source server of a service for a mobile object, which is exerted on the service;
deciding a timing to switch the provision source server on the basis of an evaluation result of the evaluating; and
giving an instruction to switch the provision source server at the timing decided by the deciding.

9. The management apparatus according to claim 8, wherein the deciding is deciding a timing at which the evaluation result is lower than a predetermined degree of influence as the timing to switch the provision source server.

10. The management apparatus according to claim 8, wherein the evaluating performs evaluation on the basis of evaluation target information including at least one of communication packet information for communication between the provision source server and the mobile object and surrounding information indicating a surrounding environment of the mobile object.

11. The management apparatus according to claim 10, wherein the surrounding information includes at least one piece of information or information analyzed on the basis of at least one piece of information among information acquired from the mobile object, information acquired from another mobile object located around the mobile object, information acquired from an information acquisition device installed in a path on which the mobile object moves, and information acquired from an information provision server.

12. The management apparatus according to claim 10, wherein the evaluation target information includes at least one of current information at a time point at which the evaluation is executed by the evaluating and prediction information obtained by predicting information of a future from the time point at which the evaluation is executed by the evaluating.

13. The management apparatus according to claim 8, wherein the management processing further includes providing an application program for providing the service or application state information indicating an operation state of the service which is provided to the mobile object by the application program to a server serving as a switching destination in response to the instruction.

14. The management apparatus according to claim 8, wherein the management apparatus is included in the provision source server or a server that manages the provision source server.

15. A management method comprising:
performing an evaluation process of evaluating a degree of influence of a server switching process of switching a provision source server of a service for a mobile object, which is exerted on the service;
performing a decision process of deciding a timing to switch the provision source server on the basis of an evaluation result of the evaluation process; and
giving an instruction to switch the provision source server at the timing decided by the decision process.

16. The management method according to claim 15, wherein the decision process includes deciding a timing at which the evaluation result is lower than a predetermined degree of influence as the timing to switch the provision source server.

17. The management method according to claim 15, wherein the evaluation process includes performing evaluation on the basis of evaluation target information including at least one of communication packet information for communication between the provision source server and the mobile object and surrounding information indicating a surrounding environment of the mobile object.

18. The management method according to claim 17, wherein the surrounding information includes at least one piece of information or information analyzed on the basis of at least one piece of information among information acquired from the mobile object, information acquired from another mobile object located around the mobile object, information acquired from an information acquisition device installed in a path on which the mobile object moves, and information acquired from an information provision server.

19. The management method according to claim 17, wherein the evaluation target information includes at least one of current information at a time point at which the evaluation is executed by the evaluation process and prediction information obtained by predicting information of a future from the time point at which the evaluation is executed by the evaluation process.

20. The management method according to claim 15, further comprising, providing an application program for providing the service or application state information indicating an operation state of the service which is provided to the mobile object by the application program to a server serving as a switching destination in response to the instruction.
